(19) United States
(12) Patent Application Publication
(10) Pub. No.: US 2011/0066327 A1
(43) Pub. Date: Mar. 17, 2011

(54) POWER STEERING APPARATUS

(75) Inventors: Makoto HORIUCHI, Yokohama-shi (JP); Kohtaro Shiino, Isehara-shi (JP)

(73) Assignee: HITACHI AUTOMOTIVE SYSTEMS, LTD.

(21) Appl. No.: 12/882,636

(22) Filed: Sep. 15, 2010

(30) Foreign Application Priority Data
Sep. 17, 2009 (JP) 2009-215312

(51) Int. Cl. B62D 6/00; G01P 21/00; H02P 6/16; B62D 3/04

(52) U.S. Cl. 701/41; 702/94; 318/400.04

(57) ABSTRACT

A power steering apparatus includes a motor unit, and a driven device such as a pump or worm gearing. The motor unit includes an electric motor and an electrical control unit which are mounted in a common housing. The electric motor is provided with a rotation sensor. The electric motor and the rotation sensor are electrically connected to the electrical control unit within the housing. The rotation sensor is calibrated before the driven device is coupled to the motor unit.

### BACKGROUND OF THE INVENTION

The present invention relates to a power steering apparatus for assisting an operator in steering operation by means of a motor, which may be adapted to a power steering system of a motor vehicle.

Japanese Patent Application Publication No. 2007-030784 discloses a power steering apparatus for a motor vehicle, which includes a motor, an electrical control unit (ECU) for driving the motor, and a rotation sensor for measuring a rotational angle of the motor. The rotation sensor is electrically calibrated by determining and memorizing a correction value for the rotation angle of the motor, after the motor and ECU are mounted as part of the power steering apparatus to a vehicle body in a vehicle assembly factory.

### SUMMARY OF THE INVENTION

For such power steering apparatuses as disclosed in Japanese Patent Application Publication No. 2007-030784, calibration of a rotation sensor in a vehicle assembly factory leads to a complicated operation in the vehicle assembly factory.

In view of the foregoing, it is desirable to provide a power steering apparatus for which calibration of a rotation sensor can be completed before shipment of the power steering apparatus as a module.

According to one aspect of the present invention, a power steering apparatus comprises: a main housing including: a motor housing section; and an electrical control unit housing section coupled to the motor housing section; a driven-device housing coupled to the motor housing section; a brushless motor including: a drive shaft housed in the motor housing section, the drive shaft including a motor-side connecting portion at an axial end portion of the drive shaft; a rotor coupled to the drive shaft; a coil disposed around the rotor, and adapted to be energized to generate a magnetic field; and a rotation sensor arranged to measure a rotation angle of the rotor; an electrical control unit housed in the electrical control unit housing section, the electrical control unit including: a memory circuit section configured to memorize a correction value for correction to a measured value of the rotation angle obtained by the rotation sensor; and a motor drive circuit section configured to drive the brushless motor on a basis of a corrected measured value of the rotation angle that is obtained by correcting the measured value with the correction value; a first electrical wiring connecting the coil and the electrical control unit to one another; a second electrical wiring connecting the rotation sensor and the electrical control unit to one another; and a driven device including: a driven shaft housed in the driven-device housing, and adapted to receive torque from the drive shaft, wherein the driven shaft includes at an axial end portion of the driven shaft a driven-side connecting portion connected to the motor-side connecting portion of the drive shaft; and an output section adapted to transmit the torque as an assist steering effort to steered wheels; wherein the correction value is set on a basis of a measured value of the rotation angle that is obtained by the rotation sensor when the rotor is rotated to a predetermined reference angular position by energization of the coil, under condition that the coil and the electrical control unit are connected to one another by the first electrical wiring, and the rotation sensor and the electrical control unit are connected to one another by the second electrical wiring.

According to another aspect of the present invention, a motor apparatus comprises: a main housing including: a motor housing section; and an electrical control unit housing section coupled to the motor housing section; a driven-device housing coupled to the motor housing section; a brushless motor including: a drive shaft housed in the motor housing section, the drive shaft including a motor-side connecting portion at an axial end portion of the drive shaft; a rotor coupled to the drive shaft; a coil disposed around the rotor, and adapted to be energized to generate a magnetic field; and a rotation sensor arranged to measure a rotation angle of the rotor; an electrical control unit housed in the electrical control unit housing section, the electrical control unit including: a memory circuit section configured to memorize a correction value for correction to a measured value of the rotation angle obtained by the rotation sensor; and a motor drive circuit section configured to drive the brushless motor on a basis of a corrected measured value of the rotation angle that is obtained by correcting the measured value with the correction value; a first electrical wiring connecting the coil and the electrical control unit to one another; a second electrical wiring connecting the rotation sensor and the electrical control unit to one another; and a driven device including: a driven shaft housed in the driven-device housing, and adapted to receive torque from the drive shaft, wherein the driven shaft includes at an axial end portion of the driven shaft a driven-side connecting portion connected to the motor-side connecting portion of the drive shaft; and an output section adapted to output a force based on the torque; wherein the correction value is set on a basis of a measured value of the rotation angle that is obtained by the rotation sensor when the rotor is rotated to a predetermined reference angular position by energization of the coil, under condition that the coil and the electrical control unit are connected to one another by the first electrical wiring, and the rotation sensor and the electrical control unit are connected to one another by the second electrical wiring.

According to a further aspect of the present invention, a calibration method for a power steering apparatus comprising: a main housing including: a motor housing section; and an electrical control unit housing section coupled to the motor housing section; a driven-device housing coupled to the motor housing section; a brushless motor including: a drive shaft housed in the motor housing section, the drive shaft including a motor-side connecting portion at an axial end portion of the drive shaft; a rotor coupled to the drive shaft; a coil disposed around the rotor, and adapted to be energized to generate a magnetic field; and a rotation sensor arranged to measure a rotation angle of the rotor; an electrical control unit housed in the electrical control unit housing section, the electrical control unit including: a memory circuit section configured to memorize a correction value for correction to a measured value of the rotation angle obtained by the rotation sensor; and a motor drive circuit section configured to drive the brushless motor; a first electrical wiring connecting the coil and the electrical control unit to one another; a second electrical wiring connecting the rotation sensor and the electrical control unit to one another; and a driven device including: a driven shaft housed in the driven-device housing, and adapted to receive torque from the drive shaft, wherein the driven shaft includes at an axial end portion of the driven shaft a driven-side connecting portion connected to the motor-side connecting portion of the drive shaft; and an output section adapted to output a force based on the torque; the calibration method comprises: a first operation of rotating the rotor to a predetermined reference angular position with respect to the coil by energization of the coil; a second operation of setting the correction value on a basis of a measured value of the rotation angle that is obtained by the rotation sensor when the rotor is rotated to the predetermined reference angular position by the first operation, for the motor drive circuit section to drive the brushless motor on a basis of a corrected measured value of the rotation angle that is obtained by correcting the measured value with the correction value; and a third operation of memorizing in the memory circuit section the correction value that is determined by the second operation.

### BRIEF DESCRIPTION OF THE DRAWINGS

FIG. 1 is a schematic diagram showing a power steering apparatus according to a first embodiment of the present invention.

FIG. 2 is a longitudinal sectional view of a motor-and-pump unit of the power steering apparatus shown in FIG. 1.

FIG. 3 is a longitudinal sectional view of a motor unit of the motor-and-pump unit shown in FIG. 2.

FIG. 4 is a bottom view of the motor unit shown in FIG. 3 under condition that the motor unit is uncovered.

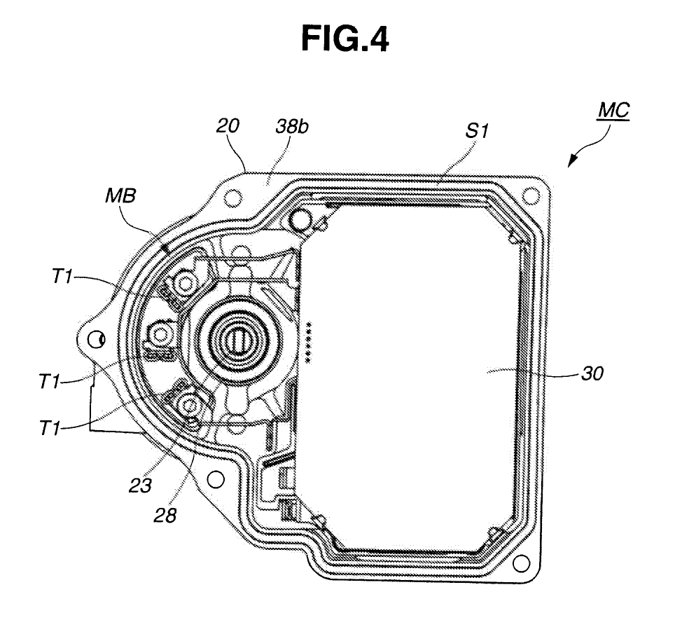

FIG. 5 is a block diagram showing an electrical control unit (ECU) of the motor unit shown in FIG. 3.

FIG. 6 is a schematic diagram showing a system for calibration of a resolver of the motor unit shown in FIG. 3.

FIG. 7 is a flow chart showing a process of calibration of the resolver.

FIG. 8 is a flow chart showing a process performed by the ECU during the process shown in FIG. 7.

FIG. 9 is a schematic diagram showing a power steering apparatus according to a second embodiment of the present invention.

FIG. 10 is a longitudinal sectional view of a motor-and-gear unit of the power steering apparatus shown in FIG. 9.

FIG. 11 is a schematic diagram showing a power steering apparatus according to a modification of the second embodiment.

### DETAILED DESCRIPTION OF THE INVENTION

In the following embodiments, a power steering apparatus is adapted to a power steering system of a motor vehicle.

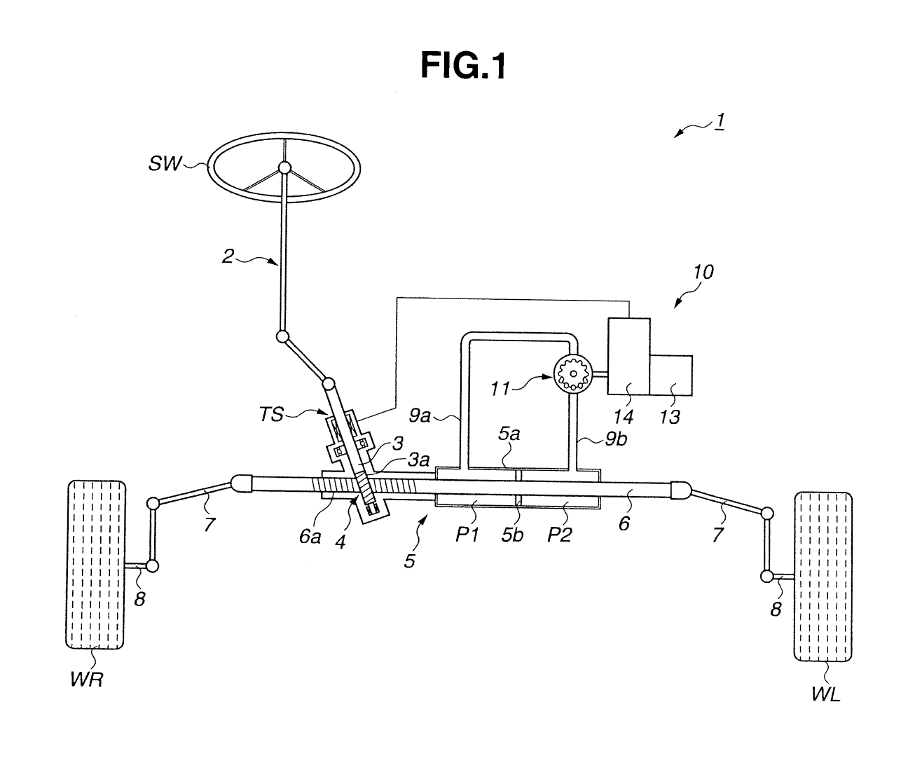

In a first embodiment, a power steering apparatus 1 is a hydraulic power steering apparatus for assisting steering operation by hydraulically boosting a thrust of a rack shaft 6. As shown in FIG. 1, power steering apparatus 1 includes an input shaft 2, an output shaft 3, a rack-and-pinion mechanism 4, a power cylinder 5, and a motor-and-pump unit 10. Input shaft 2 has one axial end coupled to a steering wheel “SW” so that the input shaft 2 and steering wheel SW rotate as a solid unit. Input shaft 2 is rotated by a steering torque that is inputted from an operator to steering wheel SW. Output shaft 3 has one axial end linked to steered wheels “WR”, “WL” through the rack-and-pinion mechanism 4, and has another axial end connected to input shaft 2 through a torsion bar not shown. Relative rotation between input shaft 2 and output shaft 3 is permitted by torsion of the torsion bar. The steering torque is transmitted from input shaft 2 to output shaft 3 through a reaction of torsion of the torsion bar, and then outputted from output shaft 3. Power cylinder 5 is arranged between output shaft 3 and steered wheels WR, WL, and combined with rack shaft 6. Power cylinder 5 includes first and second pressure chambers P1, P2 separated from one another, and are arranged to boost a steering effort outputted from output shaft 3 by a differential pressure between first and second pressure chambers P1, P2. Motor-and-pump unit 10 selectively supplies and drains working fluid to and from first and second pressure chambers P1, P2 of power cylinder 5.

In rack-and-pinion mechanism 4, a pinion gear 3a of output shaft 3 meshes with a rack gear 6a of rack shaft 6. Output shaft 3 and rack shaft 6 cross one another at or near a right angle. Pinion gear 3a is formed at the periphery of an axial end portion of output shaft 3. Rack gear 6a is formed at the periphery of a portion of rack to shaft 6 that expands over a predetermined distance in the axial direction. Rotation of output shaft 3 causes rack shaft 6 to travel in the axial direction of rack shaft 6. Each longitudinal end of rack shaft 6 is connected to a tie rod 7. Each tie rod 7 is liked to a steered wheel WR, WL through a is knuckle 8. In this arrangement, movement of rack shaft 6 in the axial direction causes tie rods 7, 7 to move knuckles 8, 8, and thereby turn steered wheels WR, WL.

Power cylinder 5 includes a cylinder tube 5a, and a piston 5b. Cylinder tube 5a is cylindrically formed. Rack shaft 6 passes through the inside of cylinder tube 5a in the axial direction of rack shaft 6, and serves as a piston rod. Piston 5b is fitted and fixed to the periphery of rack shaft 6. Piston 5b divides the internal space of cylinder tube 5a into first and second pressure chambers P1, P2. First pressure chamber P1 is connected to a first fluid line 9a leading to a pump 11. Second pressure chamber P2 is connected to a second fluid line 9b leading to pump 11. When supplied with hydraulic pressures from pump 11, first and second pressure chambers P1, P2 cause a thrust of rack shaft 6, and thereby assist steering operation.

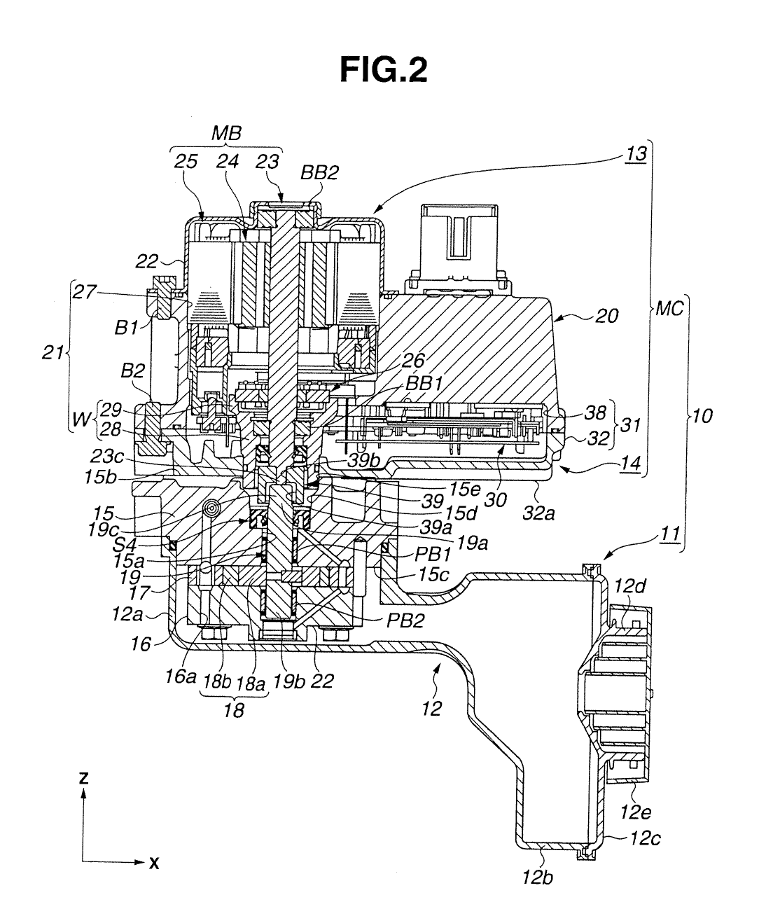

Motor-and-pump unit 10 includes pump 11, a reservoir tank 12, an electric motor 13, and an electrical control unit (ECU) 14, which are formed together as a unit, as shown in FIGS. 1 and 2. Pump 11 is a reversible type bidirectional pump for selectively supplying working fluid to first and second pressure chambers P1, P2 of power cylinder 5, and functions as a driven device of the power steering apparatus. Reservoir tank 12 stores working fluid that is circulated by pump 11. Motor 13 is a brushless motor for driving the pump 11. ECU 14 controls operation of motor 13. Reservoir tank 12, pump 11, and motor 13 are arranged in this order from one axial end to another axial end of motor-and-pump unit 10. ECU 14 is positioned on one side of motor 13. Motor-and-pump unit 10 is a unit of pump 11 and a motor unit “MC” that is a unit of motor 13 and ECU 14.

Pump 11 is of so-called an internal gear type, and includes a pump body 15, a pump cover 16, a cam ring 17, a pumping section 18, and a pump drive shaft 19, as shown in FIG. 2. Pump body 15 is formed with a shaft insertion hole 15a that extends substantially through the center of pump body 15 in the z-axis direction in FIG. 2. Pump body 15 has a first axial end surface 15b that faces an outer surface 32a of an ECU cover 32, and is in contact with the same. Pump cover 16 faces a second axial end surface 15c of pump body 15, wherein cam ring 17 is disposed between pump body 15 and pump cover 16. Cam ring 17 is annularly formed, and faces the second axial end surface 15c of pump body 15, and is in contact with the same. Cam ring 17 is thus held and fixed between pump body 15 and pump cover 16. Pumping section 18 is disposed radially inside the cam ring 17, and arranged to rotate while sucking and discharging working fluid. Pump drive shaft 19 is inserted and rotatably supported in the shaft insertion hole 15a of pump body 15, and connected to a motor drive shaft 23 through a shaft coupling 39 that is an Oldham's shaft coupling in this example. Pump drive shaft 19 functions as a driven shaft that is rotated by motor 13. When rotated by motor 13, pumping section 18 sucks working fluid from reservoir tank 12 through a suction port 16a of pump cover 16 that is formed to extend through pump cover 16 in the z-axis direction. The sucked working fluid is pressurized by rotation of pumping section 18, and discharged to first and second pressure chambers P1, P2 of power cylinder 5 through first and second fluid lines 9a, 9b.

Pump body 15 is formed with a larger diameter portion 15d at an end portion of shaft insertion hole 15a closer to motor 13. An annular seal S4 is mounted and supported in an inside end portion of larger diameter portion 15d. Seal S4 serves to seal the clearance between the inside periphery of larger diameter portion 15d of pump body 15 and the outside periphery of a first axial end portion 19a of pump drive shaft 19, and thereby prevent working fluid from leaking from the inside of pump 11 to motor 13. The larger diameter portion 15d accommodates a negative z side end portion of shaft coupling 39. At the larger diameter portion 15d, a driven-side connecting portion 19c of pump drive shaft 19 at first axial end portion 19a which extends to the open end of larger diameter portion 15d is connected to shaft coupling 39.

Pumping section 18 is fixed to the outside periphery of pump drive shaft 19 with a rotation stopper so that pumping section 18 cannot rotate relative to pump drive shaft 19. Pumping section 18 includes an inner rotor 18a and an outer rotor 18b. Inner rotor 18a has a plurality of external teeth at its outside periphery. Outer rotor 18b is disposed radially outside of inner rotor 18a, and rotatably fitted to the inside periphery of cam ring 17. Outer rotor 18b has a plurality of internal teeth meshing with the external teeth of inner rotor 18a. The external teeth of inner rotor 18a mesh with the internal teeth of outer rotor 18b at a part of the circumference, defining a plurality of pump chambers therebetween which have different sizes and different shapes.

Pump drive shaft 19 is rotatably supported with respect to pump body 15 by first and second plane bearings PB1, PB2 that are mounted in shaft insertion hole 15a of pump body 15. First plane bearing PB1 supports a central portion of pump drive shaft 19. Second plane bearing PB2 supports a second axial end portion 19b of pump drive shaft 19. Pump drive shaft 19, which extends close to the open end of larger diameter portion 15d, includes at one axial end the driven-side connecting portion 19c that is adapted to be connected to the first axial end receiving portion 39a of shaft coupling 39. The driven-side connecting portion 19c of pump drive shaft 19 is inserted into and coupled to first axial end receiving portion 39a of shaft coupling 39.

Reservoir tank 12 is L-shaped as shown in FIG. 2. Reservoir tank 12 includes a first cylindrical portion 12a, a second cylindrical portion 12b, a tank cover 12c, a cylindrical opening portion 12d, and a cap 12e. First cylindrical portion 12a is formed at one end, and has an opening directed in the positive z-axis direction. First cylindrical portion 12a is fixed to the periphery of the second axial end surface 15c of pump body 15, entirely covering the pump cover 16 and cam ring 17. The second cylindrical portion 12b of reservoir tank 12 has an opening directed in the positive x-axis direction. The opening of second cylindrical portion 12b is closed by tank cover 12c that is fixed to second cylindrical portion 12b. The tank cover 12c is formed with cylindrical opening portion 12d at the center through which working fluid is supplied from outside. The cylindrical opening portion 12d projects toward outside from the flat portion of tank cover 12c. The cylindrical opening portion 12d is closed by cap 12e that is detachable.

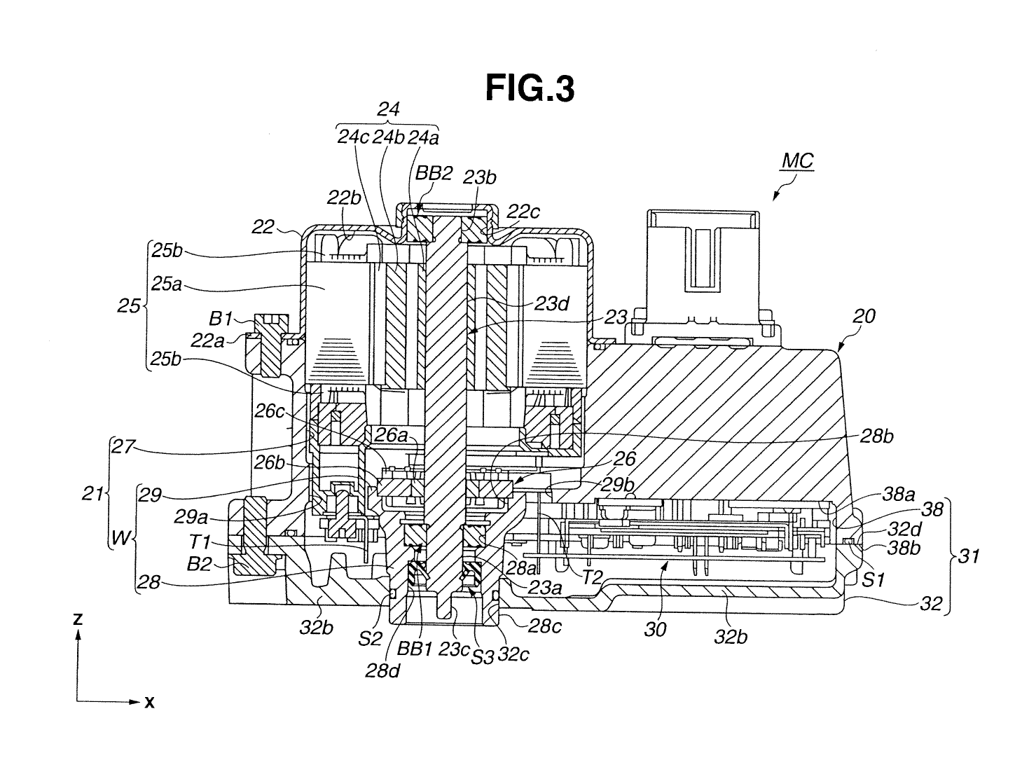

Motor 13 is a three-phase synchronous surface-mounted magnet type motor. As shown in FIGS. 2 and 3, motor 13 includes a motor body “MB”, and a resolver 26. Motor body MB includes a motor drive shaft 23, a rotor 24, and a stator 25. Motor drive shaft 23 has an axial end portion rotatably supported by a first ball bearing BB1 with respect to housing 20. First ball bearing BB1 is retained in a cylindrical portion 28 of housing 20. Rotor 24 is press-fitted to the outside periphery of motor drive shaft 23, and further fixed to motor drive shaft 23 with a rotation stopper such as a key for preventing relative rotation of rotor 24. Stator 25 is cylindrically formed, and disposed radially outside of rotor 24 with a radial clearance. Resolver 26 is disposed at the periphery of the axial end portion of motor drive shaft 23, serving as a rotation sensor.

Motor 13 is controlled by ECU 14 on the basis of sensing data of a torque sensor “TS”, and data about vehicle speed. Torque sensor TS is disposed at the periphery of input shaft 2 or output shaft 3, for sensing a steering torque inputted to input shaft 2, as shown in FIG. 1. When an operator operates the steering wheel SW, the direction of rotation and output torque of motor 13 are switched according to the operation (direction, and steering torque), to drive the pump 11 so that the power cylinder 5 produces a suitable assist steering effort.

Housing 20 is formed integrally of a die-casting aluminum, and composed of a motor housing section 21, and an ECU housing section 31. Motor 13 is mounted in motor housing section 21. ECU 14 is mounted in ECU housing section 31. The integral formation of motor housing section 21 and ECU housing section 31 serves to simplify the structure, and eliminate the necessity of connection between motor housing section 21 and ECU housing section 31. This enhances the efficiency of assembling operation, and thereby enhances the productivity.

As shown in FIG. 3, the motor housing section 21 of housing 20 is formed so that the diameter of motor housing section 21 contracts stepwise as followed in the negative z-axis direction. Motor housing section 21 includes a motor body accommodation portion 27, a cylindrical portion 28, and a stepped wall portion 29. Motor body accommodation portion 27 is formed and located on the positive z side, having a positive z side opening, and having a larger diameter. Cylindrical portion 28 is formed and located on the negative z-axis side, having a negative z side opening, and having a smaller diameter. Cylindrical portion 28 extends through the ECU housing section 31. Stepped wall portion 29 is formed between motor body accommodation portion 27 and cylindrical portion 28. Cylindrical portion 28 and stepped wall portion 29 constitute a division wall “W” that serves to separate motor housing section 21 and ECU housing section 31 from one another.

One axial end portion (negative z side end portion in FIG. 3) of motor body MB is accommodated in motor body accommodation portion 27 of motor housing section 21 of housing 20. The other axial end portion of motor body MB projects from motor body accommodation portion 27 in the positive z-axis direction. The other axial end portion is accommodated in motor cover 22 that closes the axial end opening of motor body accommodation portion 27. Namely, motor body MB extends both in motor housing section 21 and in motor cover 22 in the z-axis direction.

Motor cover 22 is formed by folding a thin plate into a hollow-cylindrical shape having a closed axial end. Motor cover 22 is formed with a flange 22a at the periphery of the open axial end, through which motor cover 22 is fixed to the open axial end surface of motor body accommodation portion 27 with a plurality of first mounting bolts B1. The closed axial end or roof 22b of motor cover 22 is formed with a second bearing accommodation portion 22c substantially at its center. Second bearing accommodation portion 22c accommodates and supports a second ball bearing BB2 by which the axial end portion of motor drive shaft 23 is rotatably supported with respect to motor cover 22.

Motor drive shaft 23 includes a medium diameter portion 23a at one axial end portion, as shown in FIG. 3. The medium diameter portion 23a is rotatably supported with respect to housing 20 by a first ball bearing BB1. First ball bearing BB1 is mounted in a first bearing accommodation portion 28a of cylindrical portion 28 that is formed substantially at the center of the inside periphery of cylindrical portion 28 in the axial direction. Motor drive shaft 23 includes a smaller diameter portion 23b at the other axial end portion. The smaller diameter portion 23b is rotatably supported with respect to housing 20 by second ball bearing BB2 that is mounted in motor cover 22. The length of motor drive shaft 23 is set so that the motor drive shaft 23 extends almost over the entire length of cylindrical portion 28 in the axial direction, and reaches the neighborhood of the negative z side end of cylindrical portion 28. Accordingly, both of motor drive shaft 23 and cylindrical portion 28 extend through the ECU housing section 31 in the axial direction. The negative z side end portion of motor drive shaft 23 is formed with a motor-side connecting portion 23c that is flatly formed in a plane containing the axis of motor drive shaft 23, and adapted to be connected to the second axial end receiving portion 39b of shaft coupling 39. The motor-side connecting portion 23c of motor drive shaft 23 is inserted into and connected to the second axial end receiving portion 39b of shaft coupling 39.

Rotor 24 includes a rotor core 24a, a plurality of magnets 24b, and a magnet cover 24c. Rotor core 24a is fixed to the periphery of the positive z side end portion of larger diameter portion 23d of motor drive shaft 23. Magnets 24b are fixed to the periphery of rotor core 24a by bonding. Magnet cover 24c is disposed radially outside of the peripheries of magnets 24b.

Stator 25 includes a stator core 25a, and a stator coil 25b attached to stator core 25a. Stator core 25a is press-fitted and fixed between motor cover 22 and the motor body accommodation portion 27 of motor housing section 21. One end portion of stator coil 25b is connected to a first electric terminal T1, and electrically connected to a control board 30 through the first electric terminal T1. First electric terminal T1 extends from stator 25 in the negative z-axis direction, and extends through a first terminal insertion hole 29a that is formed in the stepped wall portion 29 of motor housing section 21, and faces and reaches the ECU housing section 31.

Resolver 26 is fixed to the periphery of a negative z side end portion of larger diameter portion 23d of motor drive shaft 23 with a rotation stopper. Resolver 26 includes a resolver rotor 26a, and a resolver stator 26b. Resolver rotor 26a includes a plurality of rotary magnetic poles, the number of which is equal to the number of magnetic poles of rotor 24. Resolver stator 26b is disposed radially outside of the resolver rotor 26a with a radial clearance, and press-fitted to a resolver accommodation portion 28b that is formed as a recess in a positive z side end portion of cylindrical portion 28. Resolver stator 26b is formed with a plurality of magnetic poles, over each of which a sensor coil 26c is wound. One end of each sensor coil 26c is connected to a second electric terminal T2, and electrically connected to control board 30 through the second electric terminal T2. The rotation angle of motor drive shaft 23 is measured by sensing with resolver stator 26b the position of each rotary magnetic pole of resolver rotor 26a, wherein resolver rotor 26a rotates in synchronization with motor drive shaft 23. Second electric terminal T2 extends from resolver stator 26b in the negative z-axis direction, and extends through a second terminal insertion hole 29b that is formed in the stepped wall portion 29 of motor housing section 21, and faces and reaches the ECU housing section 31, similar to first electric terminal T1.

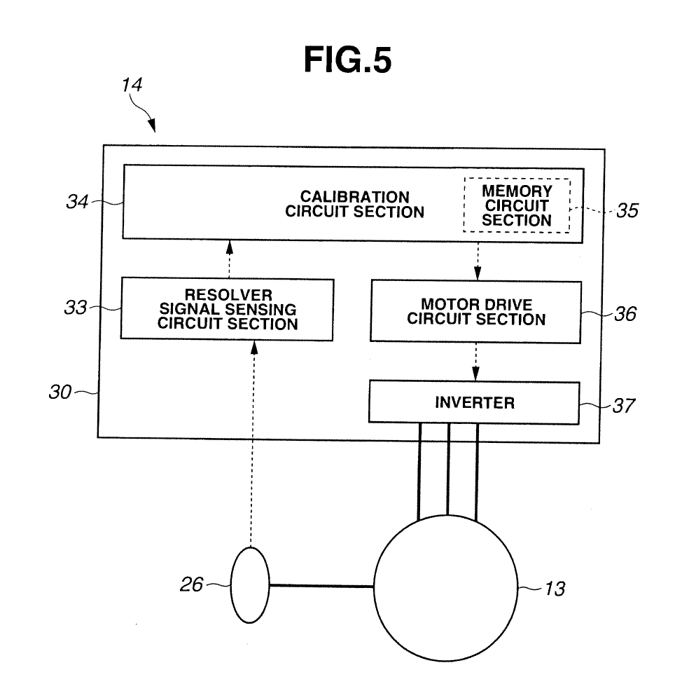

ECU 14 includes control board 30, a resolver signal sensing circuit section 33, a calibration circuit section 34, a memory circuit section 35, a motor drive circuit section (PWM motor drive circuit section) 36, and an inverter 37, as shown in FIG. 5. Control board 30 is mounted in ECU housing section 31. Resolver signal sensing circuit section 33 obtains an output signal from resolver 26. Calibration circuit section 34 determines a correction value on the basis of the output signal from resolver signal sensing circuit section 33, for calibration for canceling errors in the output signal from resolver 26 that is received by resolver signal sensing circuit section 33. Memory circuit section 35 is built in calibration circuit section 34, and configured to memorize the correction value that is determined by calibration circuit section 34. Motor drive circuit section 36 drives motor 13 or controls operation of motor 13 according to the steering torque measured by torque sensor TS, using the correction value stored in memory circuit section 35. Inverter 37 converts the magnetizing current supplied from motor drive circuit section 36.

Control board 30 is electrically connected to stator coil 25b through the first electric terminal T1 that extends through the first terminal insertion hole 29a into ECU housing section 31. Control board 30 is electrically connected to sensor coil 26c through the second electric terminal T2 that extends through the second terminal insertion hole 29b into ECU housing section 31. Namely, motor 13 and ECU 14 are electrically connected to one another within housing 20, constituting the motor unit MC. Accordingly, motor unit MC can be solely operated, without being connected to pump 11 and mounted to power steering apparatus 1. Therefore, motor unit MC can be calibrated when motor unit MC is not connected to other components.

Control board 30 is arranged close to torque sensor TS, and directly connected to torque sensor TS through a harness. This serves to simplify the structure, and make the wiring efficient.

ECU housing section 31 includes a board accommodation portion 38, and ECU cover 32, as shown in FIG. 3. Board accommodation portion 38 accommodates the control board 30, and has a wide opening through which the control board 30 can be inserted from the negative z side into the negative z side portion of housing 20. ECU cover 32 closes the opening of board accommodation portion 38.

Cylindrical portion 28 extends from a roof 38a of board accommodation portion 38 through the board accommodation portion 38, and has a tip 28c that projects out of ECU cover 32 through a through hole 32c that is formed in a bottom wall portion 32b of ECU cover 32. The tip 28c of cylindrical portion 28 is adapted to be fitted in the end portion of larger diameter portion 15d of shaft insertion hole 15a of pump body 15. This construction makes it possible to suitably position the pump body 15 with respect to motor housing section 21 of housing 20 in the radial directions.

ECU cover 32 is disposed between the open end surface 38b of board accommodation portion 38 and the first axial end surface 15b of pump body 15. ECU cover 32 is attached to the open end surface 38b of board accommodation portion 38 with a plurality of second mounting bolts B2, independently of attachment of pump body 15. Namely, the opening of board accommodation portion 38 can be closed under condition that the pump body 15 is not attached to motor housing section 21.

The open end surface 38b of board accommodation portion 38 includes a groove in which a seal S1 in the form of an O-ring is fitted. Seal S1 serves to seal the boundary between the open end surface 38b of board accommodation portion 38 and the contact surface 32d of ECU cover 32, and thereby serves to prevent dust or the like from entering the board accommodation portion 38 from outside through the boundary between the open end surface 38b and contact surface 32d. Similarly, the periphery of the tip 28c of cylindrical portion 28 includes a groove in which a seal S2 in the form of an O-ring is fitted. Seal S2 serves to seal the boundary between the inside periphery of through hole 32c and the periphery of the tip 28c of cylindrical portion 28, and thereby serves to prevent dust or the like from entering the board accommodation portion 38 through the boundary between the through hole 32c and tip 28c from outside or prevent working fluid from entering the board accommodation portion 38 from pump 11. The inside periphery of the tip 28c of cylindrical portion 28 is formed with a seal-holding portion 28d on the negative z side of first bearing accommodation portion 28a. An annular seal S3 is fitted in seal-holding portion 28d. Seal S3 serves to seal the boundary between the inside periphery of tip 28c of cylindrical portion 28 and the outside periphery of medium diameter portion 23a of motor drive shaft 23, and thereby prevent working fluid from entering the resolver accommodation portion 28b from pump 11.

In this way, seals S1, S2, S3 serve to prevent foreign matter from entering the board accommodation portion 38 from outside, even when motor unit MC is isolated from other components, i.e. even when pump body 15 is not yet attached to housing 20. This is advantageous, when calibration is performed for motor unit MC without pump 11. The entrance of foreign matter is prevented, also when motor drive shaft 23 is connected to pump drive shaft 19. Namely, the entrance of foreign matter is prevented, until the assembly of motor-and-pump unit 10 is completed after motor unit MC is assembled.

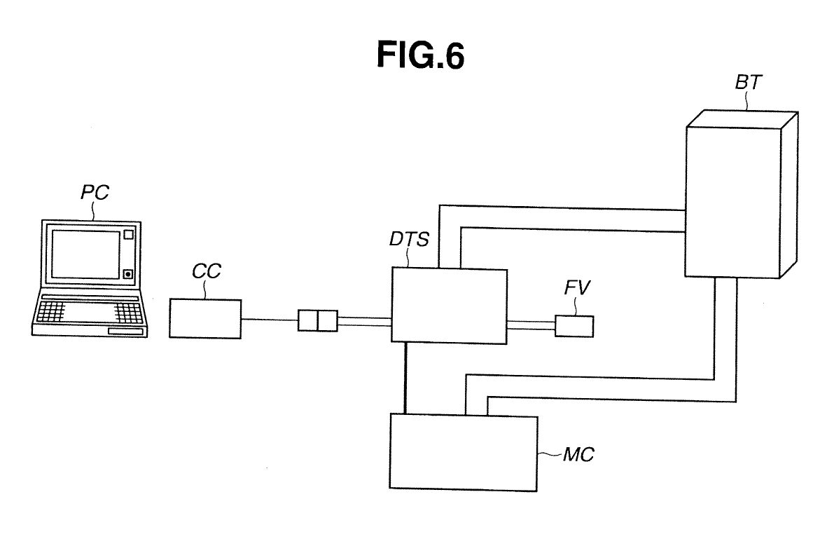

The following describes a method of calibration for resolver 26 according to this embodiment with reference to FIGS. 6 to 8.

The calibration of resolver 26 is so-called an electrical calibration, in which a correction value is determined based on errors in the sensing signal of resolver 26, and then memorized in calibration circuit section 34. The calibration makes it possible to accurately control the rotation angle of the motor 13 by supplying a magnetizing current in consideration of the correction value.

FIG. 6 schematically shows a system for calibration of resolver 26. In this system, motor unit MC is connected to a dummy torque sensor “DTS” that is connected to a fail-safe valve “FV”. Dummy torque sensor DTS is further connected to a personal computer “PC” through a CAN card “CC”. Motor unit MC and dummy torque sensor DTS are connected to a battery “BT”. Dummy torque sensor DTS and fail-safe valve FV are dummies for operating the system. Specifically, dummy torque sensor DTS and fail-safe valve FV allow ECU 14 of motor unit MC to virtually recognize the connection of torque sensor TS and a fail-safe valve not shown, where the fail-safe valve is disposed in the hydraulic circuit related to pump 11. Naturally, dummy torque sensor DTS and fail-safe valve FV may be different from actual torque sensor and fail-safe valve. Alternatively, ECU 14 may be provided with a program for simulating the connection of the torque sensor TS and the fail-safe valve, wherein the dummy torque sensor DTS and fail-safe valve FV are omitted.

For preparation for the calibration, motor 13 and ECU 14 are assembled to form the motor unit MC, as shown in FIG. 3. Specifically, motor body MB, resolver 26 and motor cover 22 are attached to motor housing section 21, and control board 30 is mounted in ECU housing section 31. Moreover, stator coil 25b and sensor coil 26c are electrically connected to control board 30. Then, board accommodation portion 38 is closed with ECU cover 32. Pump 11 is not yet attached to motor unit MC.

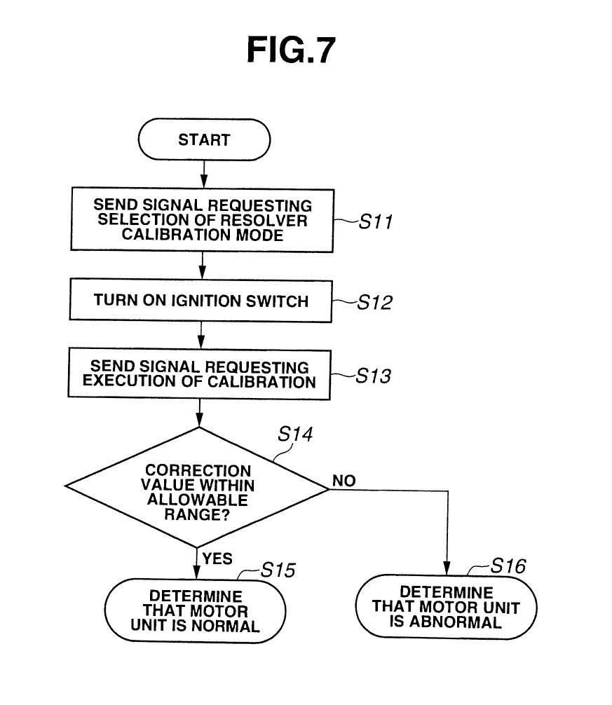

FIG. 7 shows a process of calibration of resolver 26. The process starts at Step S11 where personal computer PC sends a signal to ECU 14 of motor unit MC, where the signal requests selection of a resolver calibration mode. The process proceeds to Step S12 where an ignition switch is turned on. Then, the process proceeds to Step S13 where personal computer PC sends a signal to ECU 14, where the signal requests execution of calibration.

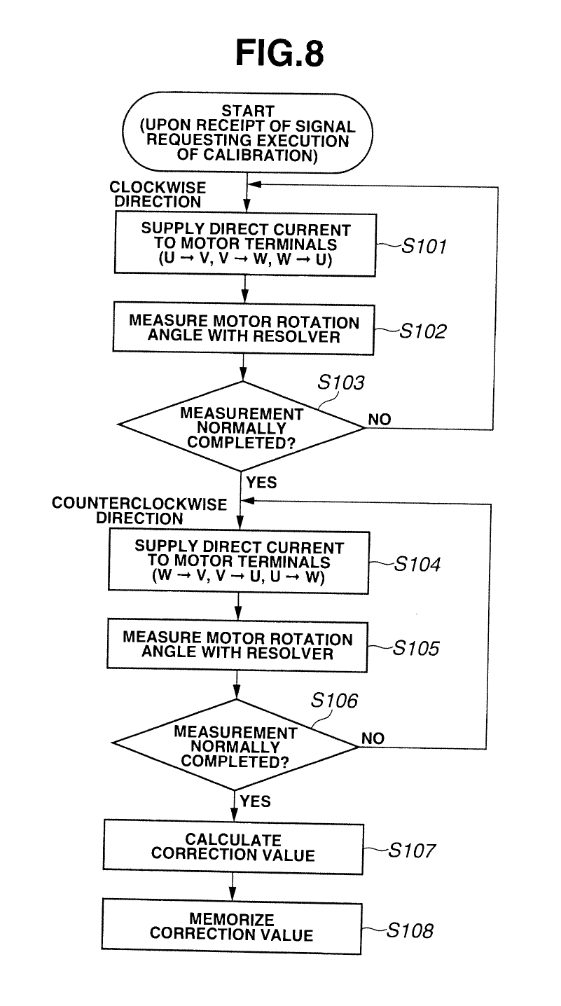

Upon receipt of the calibration execution signal, ECU 14 performs a sub-process shown in FIG. 8. ECU 14 supplies a magnetizing current to rotor 24 by supplying direct current to motor terminals so that rotor 24 rotates in a clockwise direction by a predetermined angle with respect to stator coil 25b, at steps S101. At step S102, ECU 14 measures with resolver 26 the rotation angle of rotor 24 with respect to stator coil 25b. At Step S103, ECU 14 determines whether or not the measurement is normally performed. When the answer to Step S103 is negative, then ECU 14 returns to Step S101, and repeats the operations of steps S101 and S102. On the other hand, when the answer to Step S103 is affirmative, then ECU 14 terminates the measurement for the clockwise movement, and proceeds to Step S104 for similar measurement for counterclockwise movement. At Step S104, ECU 14 supplies a magnetizing current to rotor 24 by supplying direct current to motor terminals so that rotor 24 rotates in a counterclockwise direction by a predetermined angle with respect to stator coil 25b. At step S105, ECU 14 measures with resolver 26 the rotation angle of rotor 24 with respect to stator coil 25b. At Step S106, ECU 14 determines whether or not the measurement is normally performed. When the answer to Step S106 is negative, then ECU 14 returns to Step S104, and repeats the operations of steps S104 and S105. On the other hand, when the answer to Step S106 is affirmative, then ECU 14 terminates the measurement for the counterclockwise movement, and proceeds to Step S107. At Step S107, calibration circuit section 34 calculates the correction value according to errors in the sensing signal of resolver 26, based on the result of measurement of the rotation angle of rotor 24 in the clockwise direction and counterclockwise direction. Then, at Step S108, memory circuit section 35 memorizes the calculated correction value, and then exits from the process.

After the sub-process shown in FIG. 8, at Step S14 in the flow chart of FIG. 7, personal computer PC determines whether or not the correction value determined by calibration circuit section 34 is in an allowable range, such as a range from 814 to 894 [digit]. When the answer to Step S14 is affirmative, then the process proceeds to step S15 where it is determined that the motor unit MC is a normal one, and the process of calibration is terminated. After this process, this motor unit MC is connected to pump 11. On the other hand, when the answer to Step S14 is negative, then the process proceeds to Step S16 where it is determined that the motor unit MC is an abnormal one, and resolver 26 is replaced with another. After the replacement, the process of calibration is performed again.

For the normal motor unit MC for which the process of calibration is normally completed, the motor-side connecting portion 23c of motor drive shaft 23 is connected to the driven-side connecting portion 19c of pump drive shaft 19 through the shaft coupling 39 so that torque can be transmitted from motor drive shaft 23 to pump drive shaft 19. Then, pump body 15 is fixed to housing 20, so that the motor 13 of motor unit MC is coupled to pump 11, thus completing the motor-and-pump unit 10. Then, motor-and-pump unit 10 is mounted in power steering apparatus 1, thus completing the power steering apparatus 1.

The feature that the motor unit MC is composed of motor 13 and ECU 14 that are electrically connected to one another, makes it possible to complete calibration of the resolver 26 of motor unit MC so that the correction value for the signal of resolver 26 is memorized in memory circuit section 35 of ECU 14, before motor unit MC is connected to pump 11 or mounted to power steering apparatus 1, i.e. before shipment of motor unit MC, in contrast to conventional cases where it is necessary to perform calibration after a power steering apparatus is mounted to a vehicle in a vehicle assembly factory. This serves to reduce the work load in the vehicle assembly factory, and thereby enhance the productivity of vehicle production.

If the calibration is performed when motor 13 is connected to pump 11, it may be impossible to obtain an accurate correction value, because there is a difference in friction between normal rotation and reverse rotation of pump 11, and the difference adversely affects the calibration. According to this embodiment, the feature that calibration is performed for the motor unit MC before motor unit MC is connected to pump 11 so that motor 13 is connected to pump 11, serves to prevent that the torque of motor 13 is canceled by friction due to operation of pump 11. This makes it possible to obtain an accurate correction value.

The feature that the board accommodation portion 38 in which control board 30 is mounted is closed by ECU cover 32 even when motor unit MC is not connected to pump 11, serves to prevent foreign matter, such as dust, from entering the board accommodation portion 38 when the calibration is performed under condition that motor unit MC is not connected to pump 11. This eliminates troubles, such as short circuit, which may be caused by the entrance of foreign matter into board accommodation portion 38.

The feature that the resolver 26 is constructed similar to motor 13, allows that management for preventing the entrance of foreign matter such as dust and oil (referred to as contamination management) for resolver 26 may be in a lower level, similar to that for motor 13, than that for control board 30. Both of resolver 26 and motor 13 can be similarly dealt with, because resolver 26 is disposed in motor housing section 21 together with motor 13, and motor housing section 21 and board accommodation portion 38 are separated from one another by division wall W. In this way, it is unnecessary to set the level of contamination management for resolver 26 high.

The feature that motor drive shaft 23 is positioned by fitting the tip 28c of cylindrical portion 28 of housing 20 to the opening end 15e of larger diameter portion 15d of shaft insertion hole 15a of pump body 15, serves to accurately position the motor housing section 21 and pump body 15 with respect to one another in radial directions, and thereby accurately position the motor drive shaft 23 and pump drive shaft 19 with respect to one another, because motor drive shaft 23 is supported with respect to motor housing section 21 by first ball bearing BB1 at the inside periphery of cylindrical portion 28, and pump drive shaft 19 is supported with respect to pump body 15 by first and second plane bearings PB1, PB2 at the inside periphery of shaft insertion hole 15a.

The provision of seal S2 at the boundary between cylindrical portion 28 and through hole 32c, serves to lower the risk of entrance of foreign matter in board accommodation portion 38, for the positioning structure described above.

The construction that board accommodation portion 38 is located at one axial end of motor body MB, cylindrical portion 28 passes through the board accommodation portion 38, and motor drive shaft 23 passes through the board accommodation portion 38, serves to improve the layout about electrical connection between motor body MB and control board 30.

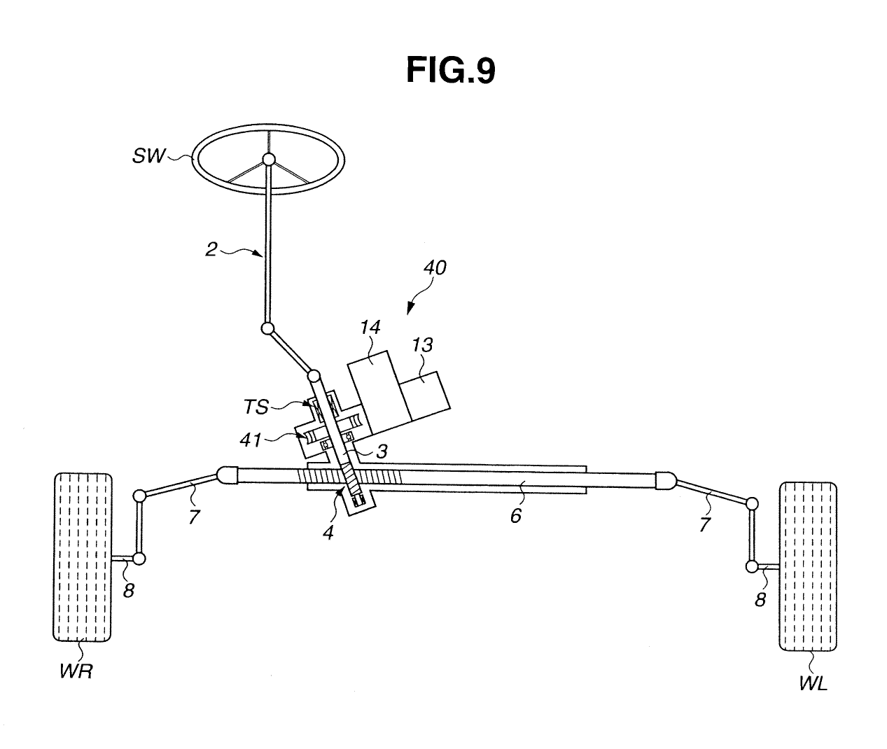

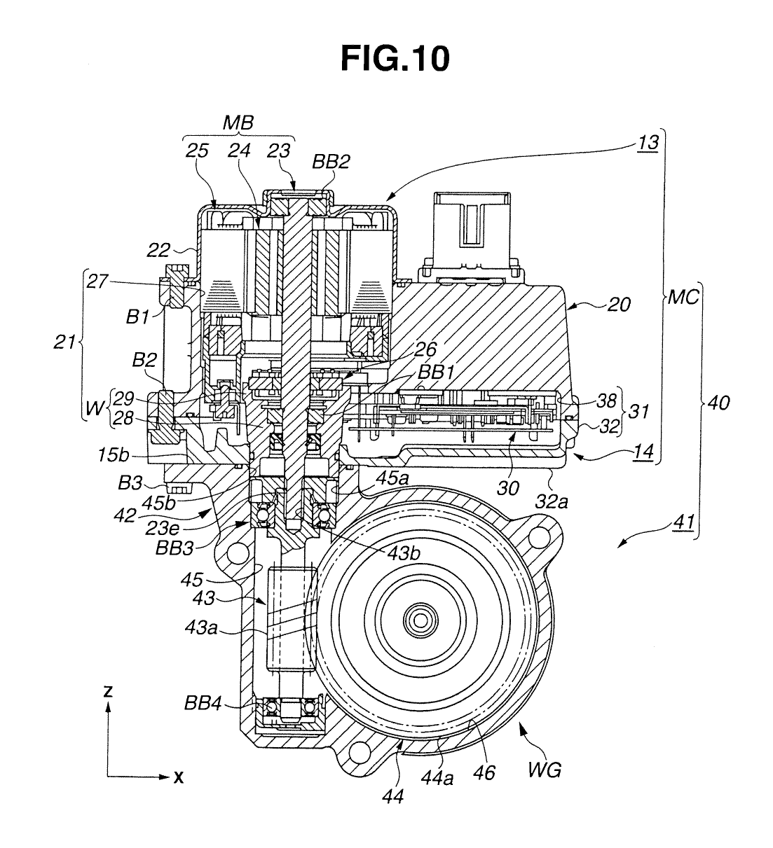

FIGS. 9 and 10 schematically show a power steering apparatus according to a second embodiment of the present invention. The power steering apparatus is adapted to an electric power steering system that is configured to assist an operator in steering operation directly based on the output torque of the motor. The basic construction, such as the construction of motor unit MC, is common between the first embodiment and second embodiment, wherein the same reference symbols are given to common components between the first embodiment and second embodiment.

As shown in FIG. 9, power steering apparatus 1 includes input shaft 2, output shaft 3, rack-and-pinion mechanism 4, and a motor-and-gear unit 40. Input shaft 2 has one axial end coupled to steering wheel SW so that the input shaft 2 and steering wheel SW rotate as a solid unit. Input shaft 2 is rotated by a steering torque that is inputted from an operator to steering wheel SW. Output shaft 3 has one axial end linked to steered wheels WR, WL through the rack-and-pinion mechanism 4, and has another axial end connected to input shaft 2 through a torsion bar not shown. Relative rotation between input shaft 2 and output shaft 3 is permitted by torsion of the torsion bar. Torque sensor TS is disposed at the periphery of input shaft 2 or output shaft 3, for sensing the steering torque based on the relative rotation between input shaft 2 and output shaft 3. Motor-and-gear unit 40 includes reducer 41, motor 13, and ECU 14, which are formed together as a unit, as shown in FIGS. 9 and 10. Namely, motor-and-gear unit 40 is a unit of reducer 41 and motor unit MC that is a unit of motor 13 and ECU 14. Motor 13 is controlled by ECU 14 on the basis of sensing data of torque sensor TS, and data about vehicle speed, for producing an assist steering torque. Reducer 41 transmits the output torque of motor 13 to output shaft 3, functioning as a driven device of the power steering apparatus. When an operator operates the steering wheel SW, the direction of rotation and output torque of motor 13 are switched according to the operation (direction, and steering torque), so that the reducer 41 outputs a suitable assist steering effort.

As shown in FIG. 10, reducer 41 includes a gear housing 42 and a worm gearing “WG”. Gear housing 42 serves also as a housing for output shaft 3. Worm gearing WG is mounted in gear housing 42, including a worm shaft 43, and a worm wheel 44. Worm shaft 43 has an axial end portion (positive z side end portion) screwed as a driven shaft to an axial end portion of motor drive shaft 23, and includes a tooth portion 43a substantially at the center in the axial direction. Worm wheel 44 is fixed to the periphery of output shaft 3, and includes a tooth portion 44a at its periphery, wherein tooth portion 44a meshes with tooth portion 43a of worm shaft 43.

Worm shaft 43 is mounted in a shaft accommodation portion 45 of gear housing 42 that is formed to extend along the axis of motor drive shaft 23. Worm wheel 44 is disposed in a wheel accommodation portion 46 of gear housing 42 that is formed to cross the shaft accommodation portion 45 and includes a portion facing the shaft accommodation portion 45.

Worm shaft 43 includes an axial end portion rotatably supported by a third ball bearing BB3 that is disposed in a larger diameter portion of shaft accommodation portion 45 at the positive z side end portion, and another axial end rotatably supported by a fourth ball bearing BB4 that is disposed at the other axial end of shaft accommodation portion 45. Worm shaft 43 is formed with a driven-side connecting portion 43b in the form of a female thread at one axial end portion of worm shaft 43, wherein the driven-side connecting portion 43b engages with a driving-side connecting portion 23e of motor drive shaft 23 that is formed as a male thread at the periphery of the axial end portion of motor drive shaft 23. Driven-side connecting portion 43b and driving-side connecting portion 23e are thus connected to one another.

The open end portion 45b of larger diameter portion 45a of shaft accommodation portion 45 is adapted to be fitted to the tip 28c of cylindrical portion 28 of motor housing section 21. Motor housing section 21 and gear housing 42 are suitably positioned with respect to one another in radial directions by fitting the tip 28c of cylindrical portion 28 into the open end portion 45b of larger diameter portion 45a of shaft accommodation portion 45. The gear housing 42 is fixed to the outer surface 32a of ECU cover 32 with a plurality of third mounting bolts B3.

As in the first embodiment, the calibration according to the second embodiment is performed when board accommodation portion 38 is dosed by ECU cover 32, but motor unit MC is not connected to reducer 41. This produces advantageous effects as described for the first embodiment. The effects are more significant in this embodiment, to obtain an accurate correction value for the rotation angle of motor 13. This is because for the worm gearing WG of reducer 41, the difference in friction between the normal direction and reverse direction is relatively large in general, but this difference does not affect the calibration and the correction value.

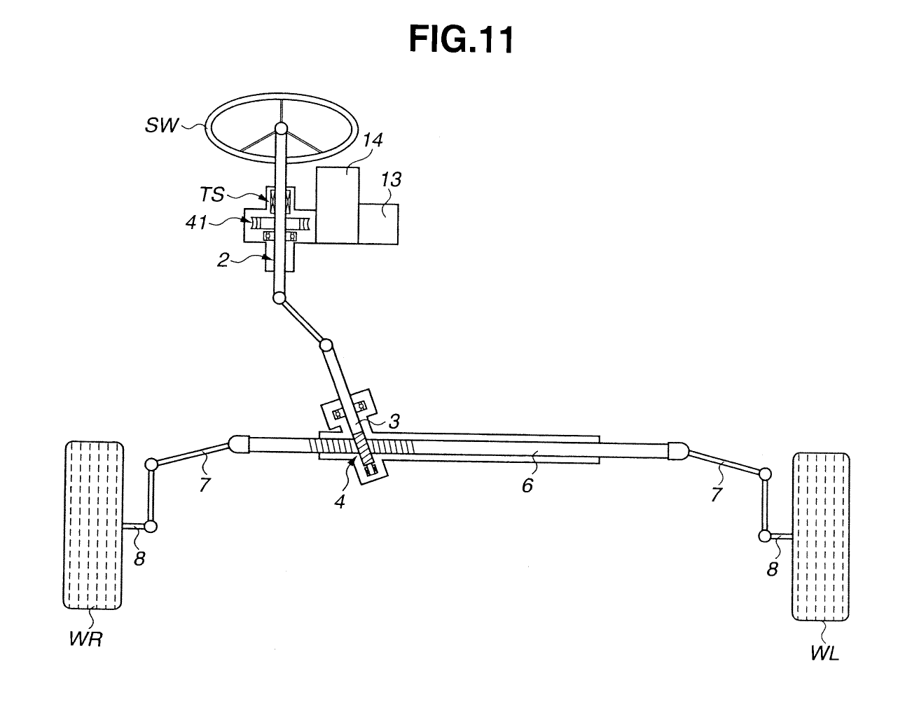

FIG. 11 shows a modification of the second embodiment in which motor-and-gear unit 40 is coupled to input shaft 2 to form a column assist type electric power steering system. This modification is advantageous similar to the second embodiment.

The present embodiments may be modified as follows. The shape of housing 20, i.e. the shapes of motor housing section 21 and ECU housing section 31 may be suitably modified according to specifications of motor unit MC and specifications of the power steering system to which the power steering apparatus is adapted. Pump 11 may be of any other type reversible pump. Reducer 41 is not limited to worm gearings, but may be of any other type reducer.

In the present embodiments, motor housing section 21 and ECU housing section 31 of housing 20 are formed integrally with one another. However, motor housing section 21 and ECU housing section 31 may be formed separately and fixed to one another with a fixing means such as a mounting bolt, if motor housing section 21 and ECU housing section 31 are positioned with respect to one another as in the present embodiments.

In the first embodiment, the motor-side connecting portion 23c of motor drive shaft 23 and the driven-side connecting portion 19c of pump drive shaft 19 are coupled by shaft coupling 39, wherein motor drive shaft 23 and pump drive shaft 19 can move with respect to one another in the axial direction. In the second embodiment, the motor-side connecting portion 23e of motor drive shaft 23 and the driven-side connecting portion 43a of worm shaft 43 are screwed to one another so that motor drive shaft 23 and worm shaft 43 are fixed to one another in the axial direction. The coupling is not so limited, if torque is suitably transmitted from motor drive shaft 23 to pump drive shaft 19 or to worm shaft 43.

The position of the connection at shaft coupling 39 between motor drive shaft 23 and pump drive shaft 19 or between motor drive shaft 23 and worm shaft 43 is not limited to the boundary between housing 20 and pump body 15 or between housing 20 and gear housing 42, but may be displaced toward motor housing section 21, or displaced toward pump body 15 or worm shaft 43. In such cases, construction is possible in which pump drive shaft 19 or worm shaft 43 extends through the cylindrical portion 28 in board accommodation portion 38.

The following summarizes features of the embodiments, and produced advantageous effects.

<1> A power steering apparatus (1) comprises: a main housing (20) including: a motor housing section (21); and an electrical control unit housing section (31) coupled to the motor housing section (21); a driven-device housing (15) coupled to the motor housing section (21); a brushless motor (13) including: a drive shaft (23) housed in the motor housing section (21), the drive shaft (23) including a motor-side connecting portion (23c) at an axial end portion of the drive shaft (23); a rotor (24) coupled to the drive shaft (23); a coil (25b) disposed around the rotor (24), and adapted to be energized to generate a magnetic field; and a rotation sensor (26) arranged to measure a rotation angle of the rotor (24); an electrical control unit (14) housed in the electrical control unit housing section (31), the electrical control unit (14) including: a memory circuit section (35) configured to memorize a correction value for correction to a measured value of the rotation angle obtained by the rotation sensor (26); and a motor drive circuit section (36) configured to drive the brushless motor (13) on a basis of a corrected measured value of the rotation angle that is obtained by correcting the measured value with the correction value; a first electrical wiring (T1) connecting the coil (25b) and the electrical control unit (14) to one another; a second electrical wiring (T2) connecting the rotation sensor (26) and the electrical control unit (14) to one another; and a driven device (11, 41) including: a driven shaft (19) housed in the driven-device housing (15), and adapted to receive torque from the drive shaft (23), wherein the driven shaft (19) includes at an axial end portion of the driven shaft (19) a driven-side connecting portion (19c) connected to the motor-side connecting portion (23c) of the drive shaft (23); and an output section (11, 5; 41) adapted to transmit the torque as an assist steering effort to steered wheels (WR, WL); wherein the correction value is set on a basis of a measured value of the rotation angle that is obtained by the rotation sensor (26) when the rotor (24) is rotated to a predetermined reference angular position by energization of the coil (25b), under condition that the coil (25b) and the electrical control unit (14) are connected to one another by the first electrical wiring (T1), and the rotation sensor (26) and the electrical control unit (14) are connected to one another by the second electrical wiring (T2). This construction makes it possible to complete calibration of the rotation sensor so that the correction value is memorized in the memory circuit section of the electrical control unit, before shipment, in contrast to conventional cases where it is necessary to perform calibration in a vehicle assembly factory. This serves to reduce the work load in the vehicle assembly factory, and thereby enhance the productivity of vehicle production.

<2> In the power steering apparatus according to item <1>, the correction value is set under condition that the driven device (11, 41) is separated from the brushless motor (13), the coil (25b) and the electrical control unit (14) are connected to one another by the first electrical wiring (T1), and the rotation sensor (26) and the electrical control unit (14) are connected to one another by the second electrical wiring (T2). The feature that the calibration is performed before the driven device is coupled to the brushless motor, serves to obtain an accurate correction value, because the output torque of the motor generated by energization of the coil is not canceled by friction, etc. in the driven device.

<3> In the power steering apparatus according to item <2>: the electrical control unit housing section (31) includes: a board accommodation portion (38) housing the electrical control unit (14); and an opening (38b) through which the electrical control unit (14) is inserted into the board accommodation portion (38); and the power steering apparatus further includes a cover (32) provided separately from the driven-device housing (15), the cover (32) closing the opening (38b). The cover serves to prevent foreign matter, such as dust or oil, from entering the board accommodation portion, even when the calibration is performed under condition that the driven-device housing is not connected to the motor housing section. This eliminates troubles, such as short circuit, which may be caused by the entrance of foreign matter into the board accommodation portion.

<4> In the power steering apparatus according to item <3>: the electrical control unit housing section (31) is arranged between the motor housing section (21) and the driven-device housing (15); and the drive shaft (23) and the driven shaft (19) are connected to form a shaft member extending through the board accommodation portion (38). This feature serves to improve the layout about electrical connection between the brush less motor and the electrical control unit, because the board accommodation portion of the electrical control unit housing section is arranged at the axial end of the brushless motor.

<5> In the power steering apparatus according to item <4>: one of the motor housing section (21) and the electrical control unit housing section (31) is provided with a division wall (W) that separates the motor housing section (21) and the board accommodation portion (38) from one another; and the rotation sensor (26) is disposed in the motor housing section (21). The feature allows that management for preventing the entrance of foreign matter such as dust and oil (contamination management) for the rotation sensor may be in a lower level, similar to that for the motor, than that for the electrical control unit. Both of the rotation sensor and the motor can be similarly dealt with, because the rotation sensor is disposed in the motor housing section together with the motor, and the motor housing section and the board accommodation portion are separated from one another by the division wall. In this way, it is unnecessary to set the level of contamination management for the rotation sensor high.

<6> In the power steering apparatus according to item <4>: the cover (32) is formed with a through hole (32c) through which the shaft member (23, 19) extends; the motor housing section (21), the electrical control unit housing section (31), and the cover (32) are formed with a cylindrical portion (28) surrounding the shaft member (23, 19); and a seal (S2) is disposed between the through hole (32c) and the cylindrical portion (28). This feature serves to prevent foreign matter, such as dust or oil, from entering the board accommodation portion, even when the calibration is performed under condition that the driven-device housing is not connected to the motor housing section.

<7> In the power steering apparatus according to item <6>, the motor housing section (21) and the electrical control unit housing section (31) are formed integrally with one another by molding. This makes it unnecessary to connect the motor housing section and the ECU housing section, and thereby improves the assembling operation.

<8> In the power steering apparatus according to item <3>: the power steering apparatus further includes a bearing (BB2) disposed in the motor housing section (21), wherein the drive shaft (23) is rotatably supported by the bearing (BB2); and the driven-device housing (15) is positioned with respect to the motor housing section (21) in a radial direction of the driven shaft (19). This feature serves to accurately position the drive shaft and the driven shaft with respect to one another.

<9> In the power steering apparatus according to item <8>, the brushless motor (13) is arranged to rotate in normal and reverse directions so as to apply assist steering effort to the steered wheels (WR, WL) in left and right steering directions. This feature serves to obtain an accurate correction value while eliminating adverse effects of friction in the driven device, even when the friction applied to the driven device is different between the normal direction and the reverse direction.

<10> In the power steering apparatus according to item <9>, the driven device (11, 41) is a worm gearing (WG). This feature serves to obtain an accurate correction value while eliminating adverse effects of friction in the driven device, even when the friction applied to the driven device is different between the normal direction and the reverse direction, although the worm gear is generally different in friction between the normal direction and the reverse direction.

<11> A motor apparatus (10, 40) comprises: a main housing (20) including: a motor housing section (21); and an electrical control unit housing section (31) coupled to the motor housing section (21); a driven-device housing (15) coupled to the motor housing section (21); a brushless motor (13) including: a drive shaft (23) housed in the motor housing section (21), the drive shaft (23) including a motor-side connecting portion (23c) at an axial end portion of the drive shaft (23); a rotor (24) coupled to the drive shaft (23); a coil (25b) disposed around the rotor (24), and adapted to be energized to generate a magnetic field; and a rotation sensor (26) arranged to measure a rotation angle of the rotor (24); an electrical control unit (14) housed in the electrical control unit housing section (31), the electrical control unit (14) including: a memory circuit section (35) configured to memorize a correction value for correction to a measured value of the rotation angle obtained by the rotation sensor (26); and a motor drive circuit section (36) configured to drive the brushless motor (13) on a basis of a corrected measured value of the rotation angle that is obtained by correcting the measured value with the correction value; a first electrical wiring (T1) connecting the coil (25b) and the electrical control unit (14) to one another; a second electrical wiring (T2) connecting the rotation sensor (26) and the electrical control unit (14) to one another; and a driven device (11, 41) including: a driven shaft (19) housed in the driven-device housing (15), and adapted to receive torque from the drive shaft (23), wherein the driven shaft (19) includes at an axial end portion of the driven shaft (19) a driven-side connecting portion (19c) connected to the motor-side connecting portion (23c) of the drive shaft (23); and an output section (11, 5; 41) adapted to output a force based on the torque; wherein the correction value is set on a basis of a measured value of the rotation angle that is obtained by the rotation sensor (26) when the rotor (24) is rotated to a predetermined reference angular position by energization of the coil (25b), under condition that the coil (25b) and the electrical control unit (14) are connected to one another by the first electrical wiring (T1), and the rotation sensor (26) and the electrical control unit (14) are connected to one another by the second electrical wiring (T2). This construction makes it possible to complete calibration of the rotation sensor so that the correction value is memorized in the memory circuit section of the electrical control unit, before shipment, in contrast to conventional cases where it is necessary to perform calibration in a process after shipment. This serves to reduce the work load in the process.

<12> In the motor apparatus according to item <11>, the correction value is set under condition that the driven device (11, 41) is separated from the brushless motor (13), the coil (25b) and the electrical control unit (14) are connected to one another by the first electrical wiring (T1), and the rotation sensor (26) and the electrical control unit (14) are connected to one another by the second electrical wiring (T2). The feature that the calibration is performed before the driven device is coupled to the brushless motor, serves to obtain an accurate correction value, because the output torque of the motor generated by energization of the coil is not canceled by friction, etc. in the driven device.

<13> In the motor apparatus according to item <12>: the electrical control unit housing section (31) includes: a board accommodation portion (38) housing the electrical control unit (14); and an opening (38b) through which the electrical control unit (14) is inserted into the board accommodation portion (38); and the motor apparatus further includes a cover (32) provided separately from the driven-device housing (15), the cover (32) closing the opening (38b). The cover serves to prevent foreign matter, such as dust or oil, from entering the board accommodation portion, even when the calibration is performed under condition that the driven-device housing is not connected to the motor housing section. This eliminates troubles, such as short circuit, which may be caused by the entrance of foreign matter into the board accommodation portion.

<14> In the motor apparatus according to item <13>: the electrical control unit housing section (31) is arranged between the motor housing section (21) and the driven-device housing (15); and the drive shaft (23) and the driven shaft (19) are connected to form a shaft member extending through the board accommodation portion (38). This feature serves to improve the layout about electrical connection between the brushless motor and the electrical control unit, because the board accommodation portion of the electrical control unit housing section is arranged at the axial end of the brushless motor.

<15> In the motor apparatus according to item <14>: the motor apparatus further includes a bearing (BB2) disposed in the motor housing section (21), wherein the drive shaft (23) is rotatably supported by the bearing (BB2); and the driven-device housing (15) is positioned with respect to the motor housing section (21) in a radial direction of the driven shaft (19). This feature serves to accurately position the drive shaft and the driven shaft with respect to one another.

<16> A calibration method for a power steering apparatus (1) comprising: a main housing (20) including: a motor housing section (21); and an electrical control unit housing section (31) coupled to the motor housing section (21); a driven-device housing (15) coupled to the motor housing section (21); a brushless motor (13) including: a drive shaft (23) housed in the motor housing section (21), the drive shaft (23) including a motor-side connecting portion (23c) at an axial end portion of the drive shaft (23); a rotor (24) coupled to the drive shaft (23); a coil (25b) disposed around the rotor (24), and adapted to be energized to generate a magnetic field; and a rotation sensor (26) arranged to measure a rotation angle of the rotor (24); an electrical control unit (14) housed in the electrical control unit housing section (31), the electrical control unit (14) including: a memory circuit section (35) configured to memorize a correction value for correction to a measured value of the rotation angle obtained by the rotation sensor (26); and a motor drive circuit section (36) configured to drive the brushless motor (13); a first electrical wiring (T1) connecting the coil (25b) and the electrical control unit (14) to one another; a second electrical wiring (T2) connecting the rotation sensor (26) and the electrical control unit (14) to one another; and a driven device (11, 41) including: a driven shaft (19) housed in the driven-device housing (15), and adapted to receive torque from the drive shaft (23), wherein the driven shaft (19) includes at an axial end portion of the driven shaft (19) a driven-side connecting portion (19c) connected to the motor-side connecting portion (23c) of the drive shaft (23); and an output section (11, 5; 41) adapted to output a force based on the torque; the calibration method comprising: a first operation of rotating the rotor (24) to a predetermined reference angular position with respect to the coil (25b) by energization of the coil (25b); a second operation of setting the correction value on a basis of a measured value of the rotation angle that is obtained by the rotation sensor (26) when the rotor (24) is rotated to the predetermined reference angular position by the first operation, for the motor drive circuit section (36) to drive the brushless motor (13) on a basis of a corrected measured value of the rotation angle that is obtained by correcting the measured value with the correction value; and a third operation of memorizing in the memory circuit section (35) the correction value that is determined by the second operation. This feature makes it possible to complete calibration of the rotation sensor so that the correction value is memorized in the memory circuit section of the electrical control unit, before shipment, in contrast to conventional cases where it is necessary to perform calibration in a process after shipment. This serves to reduce the work load in the process.

<17> In the calibration method according to item <16>, the second operation is implemented by setting the correction value under condition that the driven device (11, 41) is separated from the brushless motor (13), the coil (25b) and the electrical control unit (14) are connected to one another by the first electrical wiring (T1), and the rotation sensor (26) and the electrical control unit (14) are connected to one another by the second electrical wiring (T2). The feature that the calibration is performed before the driven device is coupled to the brushless motor, serves to obtain an accurate correction value, because the output torque of the motor generated by energization of the coil is not canceled by friction, etc. in the driven device.

<18> In the calibration method according to item <17>: the electrical control unit housing section (31) includes: a board accommodation portion (38) housing the electrical control unit (14); and an opening (38b) through which the electrical control unit (14) is inserted into the board accommodation portion (38); and the calibration method further includes an operation of dosing the opening (38b) with a cover (32) provided separately from the driven-device housing (15), before the first operation. The cover serves to prevent foreign matter, such as dust or oil, from entering the board accommodation portion, even when the calibration is performed under condition that the driven-device housing is not connected to the motor housing section. This eliminates troubles, such as short circuit, which may be caused by the entrance of foreign matter into the board accommodation portion.

<19> The calibration method according to item <18> further comprises an operation of connecting the drive shaft (23) to the driven shaft (19) after the third operation. This feature serves to obtain an accurate correction value while eliminating effects of a load of the driven device on the drive shaft. The feature further serves to enhance the efficiency of the connecting operation, because the connecting operation can be performed under condition that the motor unit is electrically separated from a system of determining and memorizing the correction value.

<20> In the calibration method according to item <19>: the motor apparatus further includes a bearing (BB2) disposed in the motor housing section (21), wherein the drive shaft (23) is rotatably supported by the bearing (BB2); and the calibration method further comprises an operation of connecting the drive shaft (23) to the driven shaft (19) after the driven-device housing (15) is positioned with respect to the motor housing section (21) in a radial direction of the driven shaft (19). This feature serves to accurately position the drive shaft and the driven shaft with respect to one another.

The entire contents of Japanese Patent Application 2009-215312 filed Sep. 17, 2009 are incorporated herein by reference.

Although the invention has been described above by reference to certain embodiments of the invention, the invention is not limited to the embodiments described above. Modifications and variations of the embodiments described above will occur to those skilled in the art in light of the above teachings. The scope of the invention is defined with reference to the following claims.

What is claimed is:

1. A power steering apparatus comprising:
a main housing including:
a motor housing section; and
an electrical control unit housing section coupled to the motor housing section;
a driven-device housing coupled to the motor housing section;
a brushless motor including:
a drive shaft housed in the motor housing section, the drive shaft including a motor-side connecting portion at an axial end portion of the drive shaft;
a rotor coupled to the drive shaft;
a coil disposed around the rotor, and adapted to be energized to generate a magnetic field; and
a rotation sensor arranged to measure a rotation angle of the rotor;
an electrical control unit housed in the electrical control unit housing section, the electrical control unit including:
a memory circuit section configured to memorize a correction value for correction to a measured value of the rotation angle obtained by the rotation sensor; and
a motor drive circuit section configured to drive the brushless motor on a basis of a corrected measured value of the rotation angle that is obtained by correcting the measured value with the correction value;
a first electrical wiring connecting the coil and the electrical control unit to one another;
a second electrical wiring connecting the rotation sensor and the electrical control unit to one another; and
a driven device including:
a driven shaft housed in the driven-device housing, and adapted to receive torque from the drive shaft, wherein the driven shaft includes at an axial end portion of the driven shaft a driven-side connecting portion connected to the motor-side connecting portion of the drive shaft; and
an output section adapted to transmit the torque as an assist steering effort to steered wheels;
wherein the correction value is set on a basis of a measured value of the rotation angle that is obtained by the rotation sensor when the rotor is rotated to a predetermined reference angular position by energization of the coil, under condition that the coil and the electrical control unit are connected to one another by the first electrical wiring, and the rotation sensor and the electrical control unit are connected to one another by the second electrical wiring.

2. The power steering apparatus as claimed in claim 1, wherein the correction value is set under condition that the driven device is separated from the brushless motor, the coil and the electrical control unit are connected to one another by the first electrical wiring, and the rotation sensor and the electrical control unit are connected to one another by the second electrical wiring.

3. The power steering apparatus as claimed in claim 2, wherein:
the electrical control unit housing section includes:
a board accommodation portion housing the electrical control unit; and
an opening through which the electrical control unit is inserted into the board accommodation portion; and
the power steering apparatus further includes a cover provided separately from the driven-device housing, the cover dosing the opening.

4. The power steering apparatus as claimed in claim 3, wherein:
the electrical control unit housing section is arranged between the motor housing section and the driven-device housing; and
the drive shaft and the driven shaft are connected to form a shaft member extending through the board accommodation portion.

5. The power steering apparatus as claimed in claim 4, wherein:
one of the motor housing section and the electrical control unit housing section is provided with a division wall that separates the motor housing section and the board accommodation portion from one another; and
the rotation sensor is disposed in the motor housing section.

6. The power steering apparatus as claimed in claim 4, wherein:
the cover is formed with a through hole through which the shaft member extends;
the motor housing section, the electrical control unit housing section, and the cover are formed with a cylindrical portion surrounding the shaft member; and
a seal is disposed between the through hole and the cylindrical portion.

7. The power steering apparatus as claimed in claim 6, wherein the motor housing section and the electrical control unit housing section are formed integrally with one another by molding.

8. The power steering apparatus as claimed in claim 3, wherein:
the power steering apparatus further includes a bearing disposed in the motor housing section, wherein the drive shaft is rotatably supported by the bearing; and
the driven-device housing is positioned with respect to the motor housing section in a radial direction of the driven shaft.

9. The power steering apparatus as claimed in claim 8, wherein the brushless motor is arranged to rotate in normal and reverse directions so as to apply assist steering effort to the steered wheels in left and right steering directions.

10. The power steering apparatus as claimed in claim 9, wherein the driven device is a worm gearing.

11. A motor apparatus comprising:
a main housing including:
a motor housing section; and
an electrical control unit housing section coupled to the motor housing section;
a driven-device housing coupled to the motor housing section;
a brushless motor including:
a drive shaft housed in the motor housing section, the drive shaft including a motor-side connecting portion at an axial end portion of the drive shaft;
a rotor coupled to the drive shaft;
a coil disposed around the rotor, and adapted to be energized to generate a magnetic field; and
a rotation sensor arranged to measure a rotation angle of the rotor;
an electrical control unit housed in the electrical control unit housing section, the electrical control unit including:
a memory circuit section configured to memorize a correction value for correction to a measured value of the rotation angle obtained by the rotation sensor; and
a motor drive circuit section configured to drive the brushless motor on a basis of a corrected measured value of the rotation angle that is obtained by correcting the measured value with the correction value;
a first electrical wiring connecting the coil and the electrical control unit to one another;
a second electrical wiring connecting the rotation sensor and the electrical control unit to one another; and
a driven device including:
a driven shaft housed in the driven-device housing, and adapted to receive torque from the drive shaft, wherein the driven shaft includes at an axial end portion of the driven shaft a driven-side connecting portion connected to the motor-side connecting portion of the drive shaft; and
an output section adapted to output a force based on the torque;
wherein the correction value is set on a basis of a measured value of the rotation angle that is obtained by the rotation sensor when the rotor is rotated to a predetermined reference angular position by energization of the coil, under condition that the coil and the electrical control unit are connected to one another by the first electrical wiring, and the rotation sensor and the electrical control unit are connected to one another by the second electrical wiring.

12. The motor apparatus as claimed in claim 11, wherein the correction value is set under condition that the driven device is separated from the brushless motor, the coil and the electrical control unit are connected to one another by the first electrical wiring, and the rotation sensor and the electrical control unit are connected to one another by the second electrical wiring.

13. The motor apparatus as claimed in claim 12, wherein:
the electrical control unit housing section includes:
a board accommodation portion housing the electrical control unit; and
an opening through which the electrical control unit is inserted into the board accommodation portion; and
the motor apparatus further includes a cover provided separately from the driven-device housing, the cover closing the opening.

14. The motor apparatus as claimed in claim 13, wherein:
the electrical control unit housing section is arranged between the motor housing section and the driven-device housing; and
the drive shaft and the driven shaft are connected to form a shaft member extending through the board accommodation portion.

15. The motor apparatus as claimed in claim 13, wherein:
the motor apparatus further includes a bearing disposed in the motor housing section, wherein the drive shaft is rotatably supported by the bearing; and
the driven-device housing is positioned with respect to the motor housing section in a radial direction of the driven shaft.

16. A calibration method for a power steering apparatus comprising: a main housing including: a motor housing section; and an electrical control unit housing section coupled to the motor housing section; a driven-device housing coupled to the motor housing section; a brushless motor including: a drive shaft housed in the motor housing section, the drive shaft including a motor-side connecting portion at an axial end portion of the drive shaft; a rotor coupled to the drive shaft; a coil disposed around the rotor, and adapted to be energized to generate a magnetic field; and a rotation sensor arranged to measure a rotation angle of the rotor; an electrical control unit housed in the electrical control unit housing section, the electrical control unit including: a memory circuit section configured to memorize a correction value for correction to a measured value of the rotation angle obtained by the rotation sensor; and a motor drive circuit section configured to drive the brushless motor; a first electrical wiring connecting the coil and the electrical control unit to one another; a second electrical wiring connecting the rotation sensor and the electrical control unit to one another; and a driven device including: a driven shaft housed in the driven-device housing, and adapted to receive torque from the drive shaft, wherein the driven shaft includes at an axial end portion of the driven shaft a driven-side connecting portion connected to the motor-side connecting portion of the drive shaft; and an output section adapted to output a force based on the torque; the calibration method comprising:
a first operation of rotating the rotor to a predetermined reference angular position with respect to the coil by energization of the coil;
a second operation of setting the correction value on a basis of a measured value of the rotation angle that is obtained by the rotation sensor when the rotor is rotated to the predetermined reference angular position by the first operation, for the motor drive circuit section to drive the brushless motor on a basis of a corrected measured value of the rotation angle that is obtained by correcting the measured value with the correction value; and
a third operation of memorizing in the memory circuit section the correction value that is determined by the second operation.

17. The calibration method as claimed in claim 16, wherein the second operation is implemented by setting the correction value under condition that the driven device is separated from the brushless motor, the coil and the electrical control unit are connected to one another by the first electrical wiring, and the rotation sensor and the electrical control unit are connected to one another by the second electrical wiring.

18. The calibration method as claimed in claim 17, wherein:
the electrical control unit housing section includes:
a board accommodation portion housing the electrical control unit; and
an opening through which the electrical control unit is inserted into the board accommodation portion; and
the calibration method further includes an operation of closing the opening with a cover provided separately from the driven-device housing, before the first operation.

19. The calibration method as claimed in claim 18, further comprising an operation of connecting the drive shaft to the driven shaft after the third operation.

20. The calibration method as claimed in claim 19, wherein:
the motor apparatus further includes a bearing disposed in the motor housing section, wherein the drive shaft is rotatably supported by the bearing; and
the calibration method further comprises an operation of connecting the drive shaft to the driven shaft after the driven-device housing is positioned with respect to the motor housing section in a radial direction of the driven shaft.
